(19) United States
(12) Patent Application Publication
(10) Pub. No.: US 2007/0006166 A1
(43) Pub. Date: Jan. 4, 2007

(54) Code coverage for an embedded processor system

(75) Inventor: Thomas Edward Daley, Woodland Park, CO (US)

Correspondence Address: David K. Lucente;Seagate Technology LLC, Intellectual Property - COL2LGL, 389 Disc Drive, Longmont, CO, 80503, US

(73) Assignee: Seagate Technology LLC

(21) Appl. No.: 11/157,199

(22) Filed: Jun. 20, 2005

(51) Int. Cl. G06F 9/44

(52) U.S. Cl. 717/129; 717/130

(57) ABSTRACT

A software code coverage tool apparatus for an intelligent storage processor. The apparatus comprises first programming instructions executable in the intelligent storage processor comprising breakpoint instructions. A patch set of programming instructions is stored in a memory portion of a host device. Second programming instructions in the host device replace the breakpoint instructions with the patch set and re-execute the first programming instructions with the patch set.

### FIELD OF THE INVENTION

The claimed invention relates generally to the field of software debugging and more particularly without limitation to debugging an intelligent storage processor in a distributed storage system.

### BACKGROUND

Computer networking began proliferating when the data transfer rates of industry standard architectures could not keep pace with the data access rate of the 80386 processor made by Intel Corporation. Local area networks (LANs) evolved to storage area networks (SANs) by consolidating the data storage capacity in the network. Users have realized significant benefits by the consolidation of equipment and the associated data handled by the equipment in SANs, such as the capability of handling an order of magnitude more storage than would otherwise be possible with direct attached storage, and doing so at manageable costs.

More recently the movement has been toward a network-centric approach to controlling the data storage subsystems. That is, in the same way that the storage was consolidated, so too are the systems that control the functionality of the storage being offloaded from the servers and into the network itself. Host-based software, for example, can delegate maintenance and management tasks to intelligent switches or to a specialized network storage services platform. Appliance-based solutions eliminate the need for the software running in the hosts, and operate within computers placed as a node in the enterprise. In any event, the intelligent network solutions can centralize such things as storage allocation routines, backup routines, and fault tolerance schemes independently of the hosts.

While moving the intelligence from the hosts to the network resolves some problems such as these, it also involves the use of sophisticated embedded processors executing software and logic modules. Because these intelligent storage processors function independently of secondary storage means, such as disc drives or tape drives, they are typically equipped with only nonalterable memory such as read-only memory (“ROM”). The permanently stored software routines (referred to as firmware) control the functionalities of the intelligent storage processor.

As intelligent storage processor system complexities increase, and as marketing expectations demand ultimate flexibility in product offerings, it becomes ever more likely that firmware errors can be created. This makes debugging of the software executed by the embedded processors an essential step early in the product design phase. Because of the limited storage capacity of the intelligent storage processor, however, it is usually impossible to run debugging programs within the computing capacity of the processor. Many solutions rely on connecting a logic analyzer to the embedded processor to compare outputs to selected inputs. What is needed, however, is a flexible debugging tool giving the user the ability to precisely track the lines of the software as it is executed, pinpointing execution errors before they compound beyond the ability to determine root cause of the error. It is to this solution that embodiments of the present invention are directed.

### SUMMARY OF THE INVENTION

Embodiments of the present invention are generally directed to devices and methods for debugging software.

In some embodiments a software code coverage tool apparatus is provided for an intelligent storage processor. The apparatus comprises first programming instructions executable in the intelligent storage processor comprising breakpoint instructions. A patch set of programming instructions is stored in a memory portion of a host. Second programming instructions in the host replace the breakpoint instructions with the patch set.

In some embodiments a method is provided for measuring code coverage. The method provides an intelligent storage processor in communication with the host comprising a memory with a code patch stored therein. The method further provides programming code executable in the intelligent storage processor comprising breakpoint instructions referencing the code patch. The method executes the programming code on the intelligent storage processor, and during the executing step, discerns the breakpoint instructions. The method then replaces the breakpoint instructions with the code patch in the programming code.

In some embodiments a storage device is provided, comprising an intelligent storage processor controlling data storage activities, and means for analyzing code coverage of software executed by the intelligent storage processor.

These and various other features and advantages which characterize the claimed invention will become apparent upon reading the following detailed description and upon reviewing the associated drawings.

### BRIEF DESCRIPTION OF THE DRAWINGS

FIG. 1 is a diagrammatic representation of a distributed computer system in which embodiments of the present invention are useful.

FIG. 2 is an exploded isometric view of an intelligent data storage subsystem constructed in accordance with embodiments of the present invention.

FIG. 3 is a functional block diagram of the intelligent data storage subsystem of FIG. 2.

FIG. 4 is a functional block diagram of the intelligent storage processor circuit board of the intelligent data storage subsystem of FIG. 3.

FIG. 5 is a functional block diagram of the intelligent storage processor of the intelligent storage processor circuit board of FIG. 4.

FIG. 6 is a diagrammatic illustration of software code from the host that is executed by the intelligent storage processor.

FIG. 7 is a diagrammatic illustration of a plurality of code patches stored within memory of the host.

FIG. 8 is a flow chart of steps performed in a method for analyzing code coverage in accordance with embodiments of the present invention.

### DETAILED DESCRIPTION

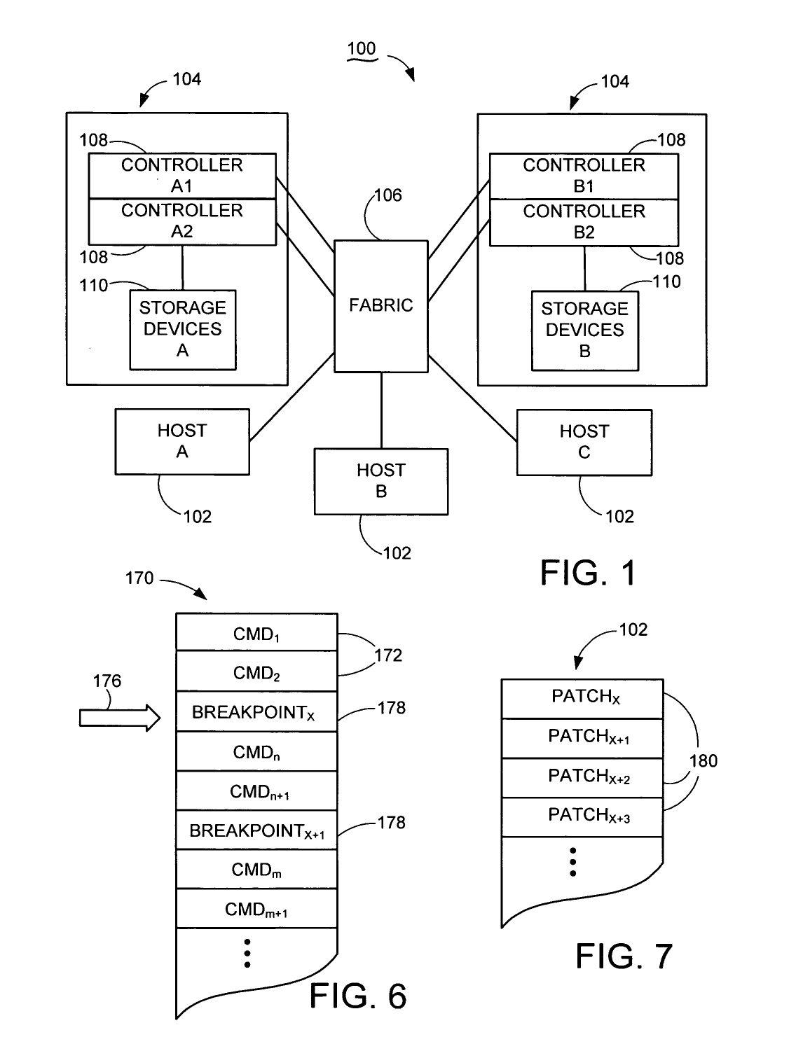

FIG. 1 is an illustrative computer system 100 in which embodiments of the present invention are useful. A plurality of hosts 102 interact with each other as well as with a pair of intelligent data storage subsystems 104 (denoted A and B, respectively) via a network or fabric 106. Each intelligent data storage subsystem 104 includes dual redundant controllers 108 (denoted A1, A2 and B1, B2) preferably operating on a data storage capacity 110, such as a set of data storage devices characterized as a redundant array of independent drives (RAID). The controllers 108 and data storage capacity 110 preferably utilize a fault tolerant arrangement so that the various controllers 108 utilize parallel, redundant links and at least some of the user data stored by the system 100 is stored in redundant formats within at least one set of the data storage capacities 110.

It is further contemplated that the A host computer 102 and the A intelligent data storage subsystem 104 can be physically located at a first site, the B host computer 102 and B intelligent data storage subsystem 104 can be physically located at a second site, and the C host computer 102 can be yet at a third site, although such is merely illustrative and not limiting. All entities on the distributed computer system are connected over some type of computer network.

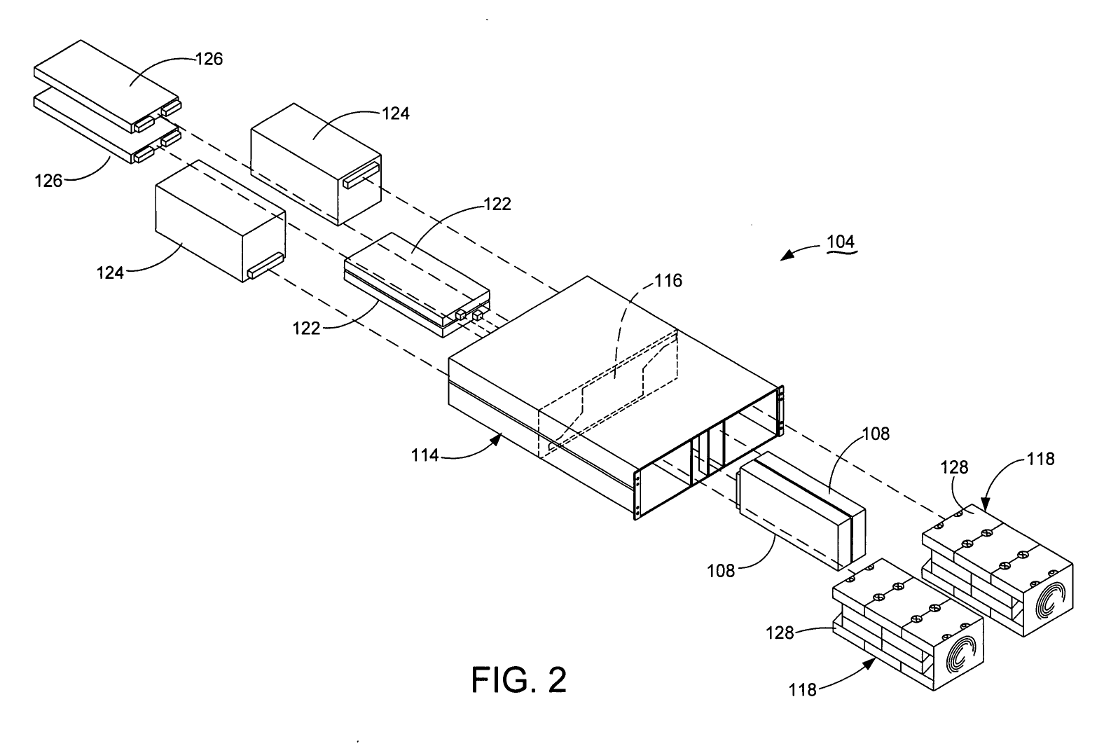

FIG. 2 illustrates an intelligent data storage subsystem 104 constructed in accordance with embodiments of the present invention. A shelf 114 defines cavities for receivingly engaging the controllers 108 in electrical connection with a midplane 116. The shelf 114 is supported, in turn, within a cabinet (not shown). A pair of multiple disc assemblies (MDAs) 118 is receivingly engageable with the shelf 114 on the same side of the midplane 116. Connected to the opposing side of the midplane 116 are dual batteries 122 providing an emergency power supply, dual alternating current power supplies 124, and dual interface modules 126. Preferably, the dual components are configured for operating either of the MDAs 118 or both simultaneously, thereby providing backup protection in the event of a component failure.

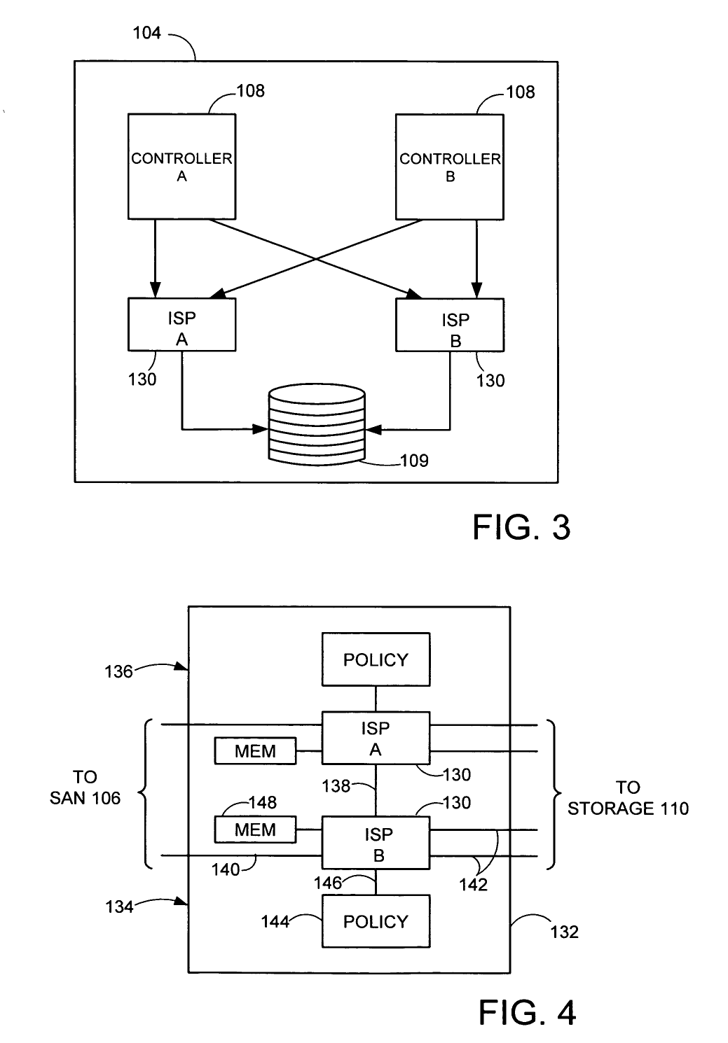

FIG. 3 is a diagrammatic view of an intelligent data storage subsystem 104 constructed in accordance with embodiments of the present invention. The controllers 108 operate in conjunction with redundant intelligent storage processors (ISP) 130 to provide managed reliability of the data integrity. The intelligent storage processors 130 can be resident in the controller 108, in the MDA 118, or elsewhere within the intelligent data storage subsystem 104. Aspects of the managed reliability include invoking reliable data storage formats such as RAID strategies. Managed reliability can also include scheduling of diagnostic and correction routines based on a monitored usage of the system. Data recovery operations are executed for copying and reconstructing data. These and other aspects of the managed reliability aspects contemplated herein are disclosed in patent application Ser. No. 10/817,617 entitled Managed Reliability Storage System and Method which is assigned to the present assignee and incorporated herein by reference. Other aspects of the managed reliability include responsiveness to predictive failure indications in relation to predetermined rules, as disclosed for example in patent application Ser. No. 11/040,410 entitled Deterministic Preventive Recovery From a Predicted Failure in a Distributed Storage System which is assigned to the present assignee and incorporated herein by reference.

FIG. 4 is a diagrammatic illustration of an intelligent storage processor circuit board 132 in which resides the pair of redundant intelligent storage processors 130. The intelligent storage processor 130 interfaces the data storage capacity 110 to the network or fabric 106. Each intelligent storage processor 130 can manage assorted storage services such as routing, volume management, and data migration and replication. The intelligent storage processors 130 divide the board 132 into two ISP subsystems 134, 136 coupled by a bus 138. The ISP subsystem 134 includes the ISP 130 denoted “B” which is connected to the fabric 106 and the storage capacity 110 by links 140, 142, respectively. The ISP subsystem 134 also includes a policy processor 144 executing a real-time operating system. The ISP 134 and policy processor 144 communicate over bus 146, and both communicate with memory 148.

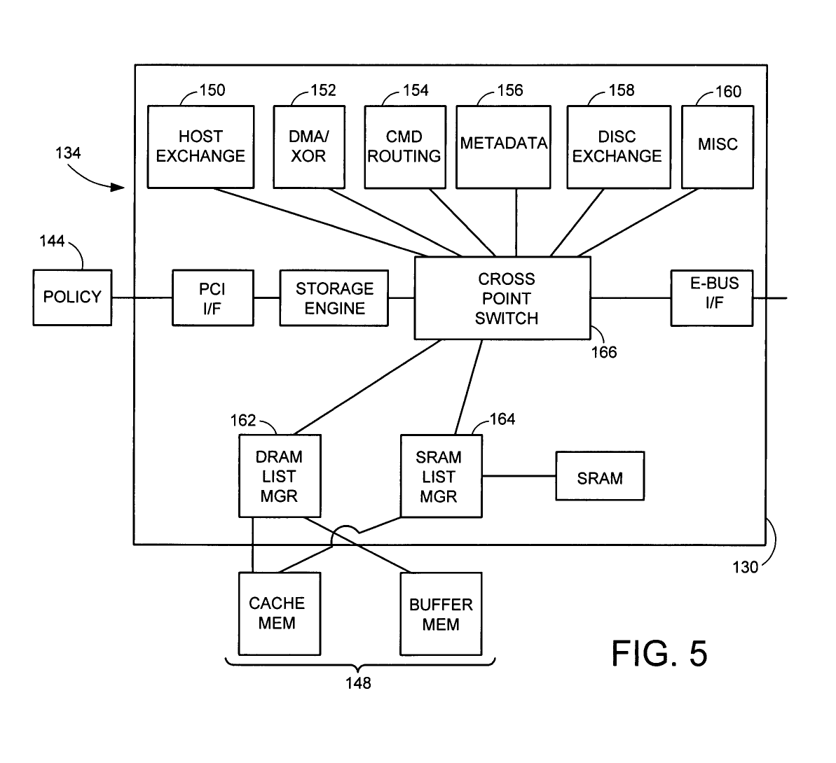

FIG. 5 is a diagrammatic view of an illustrative ISP subsystem 134 constructed in accordance with embodiments of the present invention. The ISP 130 includes a number of functional controller cores (“FCC” 150-160) in communication with list managers 162, 164 via a cross point switch (“CPS”) 166 message crossbar. Accordingly, the controllers (150-160) can each generate CPS messages in response to a given condition and send the messages through the CPS 166 to a list manager 162, 164 in order to access a memory module and/or invoke an ISP 130 action. Likewise, responses from a list manager 162, 164 can be communicated to any of the controllers (150-160) via the CPS 166. The arrangement of FIG. 5 and associated discussion are illustrative and not limiting of the contemplated embodiments of the present invention.

The policy processor 144 can be programmed to execute desired operations via the ISP 130. For example, the policy processor 144 can communicate with the list managers 162, 164, that is, send and receive messages, via the CPS 166. Responses to the policy processor 144 can serve as interrupts signaling the reading of memory 148 registers.

FIGS. 6-9 diagrammatically represent a software code coverage tool apparatus constructed in accordance with embodiments of the present invention for debugging software executed by the intelligent storage processor 130. FIG. 6 represents first programming instructions 170, preferably in the form of software, that are provided by the policy processor 144, (sometimes referred to herein as “host” in that the policy processor 144 functions as the controlling host for the ISP 130) and executed in the intelligent storage processor 130. In this arrangement the host 144 functions as the development system, and the ISP 130 functions as the target system. The first programming instructions 170 comprise command sequences, such as 172 that are sequentially executed by a program counter 176. The first programming instructions 170 also comprise breakpoint instructions 178.

The software code coverage tool further comprises one or more patch sets of programming instructions 180 stored within memory in the host 144. When the program counter 176 discerns a breakpoint instruction 178, a respective patch set of programming instructions 180 are recalled from the host 144 and written to the first programming instructions 170, replacing the respective breakpoint instructions 178.

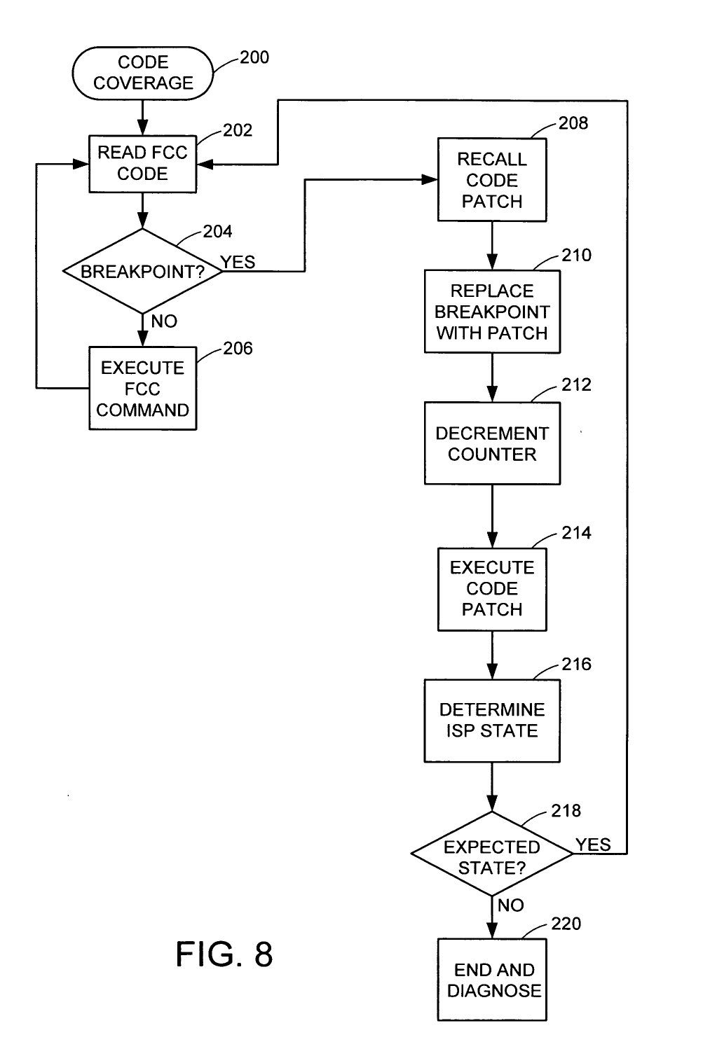

FIG. 8 is a flowchart illustrating steps performed by second programming instructions in the host 144 for practicing a method 200 of measuring code coverage in accordance with embodiments of the present invention. The method begins at step 202 wherein control is vested by the host 144 in the first set of programming instructions 170 in sequencing through the command sequences 172. At decision block 204 it is determined whether breakpoint instructions 178 have been discerned by the ISP 130. Preferably, the ISP 130 alone monitors for the occurrence of the breakpoint instructions 178 and then notifies the host 144 of such by means of an interrupt. Otherwise, there is no need for communication between the host 144 and the ISP 130 in the absence of an occurrence of the breakpoint instructions 178. If the determination of block 204 is no, then the latest command sequence 172 is executed in block 206 and control returns to block 202 where the program counter 176 is incremented.

If, however, the determination of block 204 is yes, then control passes from the first programming instructions 170 to the host 144. In block 208 the patch code 180 is read from the host 144, and in block 210 the patch code 180 is written to the software code 170, replacing the breakpoint instructions 178. In block 212 the program counter 176 is decremented in relation to the starting address of the previously stored breakpoint instructions 178, so that in block 214 the portion of the software code 170 now comprising the patch code 180 can be executed.

After the patch code 180 has been executed, the host 144 then compares the ISP 130 existing state to an expected state in block 216. If, in block 218 it is determined that the existing state is as expected, meaning that no software execution errors are detected, then control passes back to the software 170 control in block 202. Otherwise, the method 200 can be ended in block 220 so that the existing state can be used to debug the software 170.

The host 144 can log the successful execution of the patch code 180 for reference in analyzing the code coverage. Also, it can be advantageous for the host 144 to single-step the execution of the patch code 180 to aid in detecting processing errors, especially where multiple branching alternatives are to be individually analyzed.

The illustrative embodiments of FIG. 6 show only two discreet breakpoint information 178 entries, but in alternative equivalent embodiments more than two can be employed. By “discreet” it is meant that sequential breakpoints 178 are separated by one or more command sequences 172. In equivalent alternative embodiments one or more sequential command sequences 172, or all command sequences 172, can include the breakpoint instructions 178.

In summary, a software code coverage tool apparatus (such as 144, 130, 200) is provided for debugging software controlling an intelligent storage processor (such as 130). The tool comprises first programming instructions executable in the intelligent storage processor comprising breakpoint instructions. A patch set of programming instructions are stored in a memory portion of the intelligent storage processor controlling host (sometimes referred to herein as “policy processor”). Second programming instructions in the host replace the breakpoint instructions with the patch set.

Preferably, the second programming instructions re-execute a portion of the first programming instructions that comprises the patch set. The second programming instructions can decrement a programming counter in relation to a starting address of the breakpoint instructions in re-executing the patch set portion of the first programming instructions.

The first programming instructions can comprise a plurality of discreet breakpoint instructions, and the host can likewise comprise a corresponding plurality of patch sets referenced by the respective breakpoint instructions. The second programming instructions can compare the state of the intelligent storage processor to an expected state after re-executing the first programming instructions with a particular patch set, and can deterministically pass control back to the first programming instructions.

In some embodiments the second programming instructions records a particular patch set has been executed when passing control back to the first programming instructions. The second programming instructions can furthermore single-step the re-execution of the first programming instructions.

In some embodiments a method is provided for measuring code coverage. The method comprises providing the host device with a memory for storing a code patch (such as 180) therein. The method further comprises providing programming code, preferably software, that is executable in the intelligent storage processor and that comprises breakpoint instructions (such as 178) referencing the code patch. The method executes the programming code (such as 206) in the intelligent storage processor, and during the executing step, discerns the breakpoint instructions (such as 204). The method accordingly replaces the breakpoint instructions with the code patch in the programming code (such as 210).

Preferably the method comprises re-executing a portion of the programming code that comprises the code patch. The replacing step can comprise decrementing a programming counter (such as 212) in relation to a starting address of the breakpoint instructions in re-executing the code patch. The programming code step preferably comprises a plurality of discreet breakpoint instructions, and the host likewise comprises a corresponding plurality of code patches referenced by the respective breakpoint instructions.

The method can further comprise comparing the state of the intelligent storage processor to an expected state after re-executing the programming code with the code patch (such as 216) and deterministically passing control back to the programming code (such as 218). The comparing step can comprise recording a code patch has been executed when passing control back to the programming code. The comparing step can further comprise single-stepping the re-execution of the programming code.

In some embodiments a storage device is contemplated, comprising an intelligent storage processor controlling data storage activities, and means for analyzing code coverage of software controlling programming steps of the intelligent storage processor. The means for analyzing code coverage can be characterized by storing breakpoints in programming code executed by the intelligent storage processor. The means for analyzing code coverage can be characterized by storing code patches in the host device. The means for analyzing code coverage can be characterized by replacing a particular breakpoint with a corresponding code patch. The means for analyzing code coverage can be characterized by re-executing a portion of the programming code comprising the code patch. The means for analyzing code coverage can be characterized by deterministically continuing to execute the programming code in relation to an observed state of the intelligent storage device after re-executing the code patch portion of the programming code.

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the present invention to the full extent indicated by the broad general meaning of the terms in which the appended claims are expressed. For example, the particular elements may vary depending on the particular processing environment without departing from the spirit and scope of the present invention.

In addition, although the embodiments described herein are directed to a data storage array, it will be appreciated by those skilled in the art that the claimed subject matter is not so limited and various other processing systems can be utilized without departing from the spirit and scope of the claimed invention.

What is claimed is:

1. A software code coverage tool apparatus for an intelligent storage processor, comprising:
first programming instructions executable in the intelligent storage processor comprising breakpoint instructions;
a patch set of programming instructions stored in a memory portion of a host device; and
second programming instructions in the host for replacing the breakpoint instructions with the patch set.

2. The apparatus of claim 1 wherein the second programming instructions re-executes a portion of the first programming instructions that comprises the patch set.

3. The apparatus of claim 2 wherein the second programming instructions decrements a programming counter in relation to a starting address of the breakpoint instructions to re-execute the patch set portion of the first programming instructions.

4. The apparatus of claim 2 wherein the first programming instructions comprise a plurality of discreet breakpoint instructions and the host comprises a corresponding plurality of patch sets referenced by the respective breakpoint instructions.

5. The apparatus of claim 4 wherein the second programming instructions compares the state of the intelligent storage processor to an expected state after re-executing the first programming instructions with a particular patch set, and deterministically passes control back to the first programming instructions.

6. The apparatus of claim 5 wherein the second programming instructions records a particular patch set has been executed when passing control back to the first programming instructions.

7. The apparatus of claim 2 wherein the second programming instructions single-steps the re-execution of the first programming instructions.

8. A method for measuring code coverage comprising:
providing an intelligent storage processor;
providing programming code from a host device executable in the intelligent storage processor and comprising breakpoint instructions referencing a code patch stored in the host;
executing the programming code in the intelligent storage processor;
during the executing step, discerning the breakpoint instructions; and
replacing the breakpoint instructions with the code patch in the programming code.

9. The method of claim 8 wherein the replacing step comprises re-executing a portion of the programming code that comprises the code patch.

10. The method of claim 9 wherein the replacing step comprises decrementing a programming counter in relation to a starting address of the breakpoint instructions in re-executing the code patch.

11. The method of claim 8 wherein the providing programming code step comprises a plurality of discreet breakpoint instructions referencing a corresponding plurality of code patches.

12. The method of claim 9 further comprising comparing the state of the intelligent storage processor to an expected state after re-executing the programming code with the code patch and deterministically passing control back to the programming code.

13. The method of claim 12 wherein the comparing step comprises recording that a code patch has been executed when passing control back to the programming code.

14. The method of claim 13 wherein the comparing step comprises single-stepping the re-execution of the programming code.

15. A storage device, comprising:
an intelligent storage processor controlling data storage activities; and
means for analyzing code coverage of software executed by the intelligent storage processor.

16. The device of claim 15 wherein the means for analyzing code coverage is characterized by storing breakpoints in programming code executed by the intelligent storage processor.

17. The device of claim 16 wherein the means for analyzing code coverage is characterized by storing code patches in a host device.

18. The device of claim 17 wherein the means for analyzing code coverage is characterized by replacing a particular breakpoint with a corresponding code patch.

19. The device of claim 18 wherein the means for analyzing code coverage is characterized by re-executing a portion of the programming code comprising the code patch.

20. The device of claim 19 wherein the means for analyzing code coverage is characterized by deterministically continuing to execute the programming code in relation to an observed state of the intelligent storage device after re-executing the code patch portion of the programming code.
